(19) United States
(12) Patent Application Publication
(10) Pub. No.: US 2023/0300268 A1
(43) Pub. Date: Sep. 21, 2023

(54) INFORMATION PROCESSING APPARATUS, IMAGE FORMING APPARATUS, AND METHOD OF INSTALLING AN APPLICATION PROGRAM THEREFOR

(71) Applicant: TOSHIBA TEC KABUSHIKI KAISHA, Tokyo (JP)

(72) Inventor: Shigeo UCHIDA, Mishima Shizuoka (JP)

(21) Appl. No.: 17/986,295

(22) Filed: Nov. 14, 2022

(30) Foreign Application Priority Data
Mar. 18, 2022 (JP) 2022-043845

(51) Int. Cl. H04N 1/00; G06F 8/61

(52) U.S. Cl. CPC H04N 1/0097; H04N 1/00938; H04N 1/00408; G06F 8/61; H04N 2201/0094

(57) ABSTRACT

According to an embodiment, an information processing apparatus installs various application programs according to an installation application program. Further, the information processing apparatus installs, when installing an installation application program, an installation application program according to a proxy installation application program.

### CROSS-REFERENCE TO RELATED APPLICATIONS

This application is based upon and claims the benefit of priority from the prior Japanese Patent Application No. 2022-043845, filed on Mar. 18, 2022, the entire contents of which are incorporated herein by reference.

### FIELD

An embodiment described herein generally relates to an information processing apparatus, an image forming apparatus, and a method of installing an application program for those apparatuses.

### BACKGROUND

There are installation application programs for installing application programs. In recent years, image forming apparatuses have been equipped with installation application programs in some cases. During the operation of an application program that operates by an application program to be installed, the installation application program has temporality stopped the operation of the application program in operation and then installed a program to be installed. This is because the application program in operation may be performing a file access during its operation. If a file or folder is updated to install an application program to be installed in the state where a file access is being performed, the file may be damaged.

However, if the installation application program stops its operation when an installation application program is installed, the installation application program cannot be installed. In other words, there has been a problem that the installation application program cannot be installed.

### BRIEF DESCRIPTION OF THE DRAWINGS

FIG. 1 is an outer appearance view showing an overall configuration example of an image forming apparatus according to an embodiment.

FIG. 2 is a block diagram showing a configuration of a system controller that is a control system of the image forming apparatus according to the embodiment.

FIG. 3 is a flowchart showing processing by an installation application program according to the embodiment.

FIG. 4 is a flowchart showing processing by a proxy installation application program according to the embodiment.

FIG. 5 is a flowchart showing processing by an installation application program at the time of restart according to the embodiment.

### DETAILED DESCRIPTION

According to one embodiment, an information processing apparatus is equipped with an installation application program for installing various application programs. The information processing apparatus includes a control panel, a storage device, and a processor. The control panel displays an instruction screen for receiving a user's installation instruction of an application program and receives the user's installation instruction input according to the instruction screen. The storage device stores the installation application program and a proxy installation application program. The installation application program is an application program stored in advance for installing various application programs. The proxy installation application program is an application program for installing a new installation application program instead of the installation application program. The processor is configured to activate the installation application program and cause the control panel to display the instruction screen. The processor is configured to receive, by the control panel, the installation instruction of an application program. The processor is configured to activate the proxy installation application program if the application program instructed by the installation instruction is the installation application program.

The installation application program according to the embodiment allows its own program (new installation application program) to be installed. Hereinafter, an installation application program according to an embodiment and an information processing apparatus equipped with an installation application program will be described in detail with reference to the drawings. In the drawings, the same reference symbols indicate the same or similar portions. In this embodiment, an image forming apparatus will be described as an example of an information processing apparatus equipped with an installation application program.

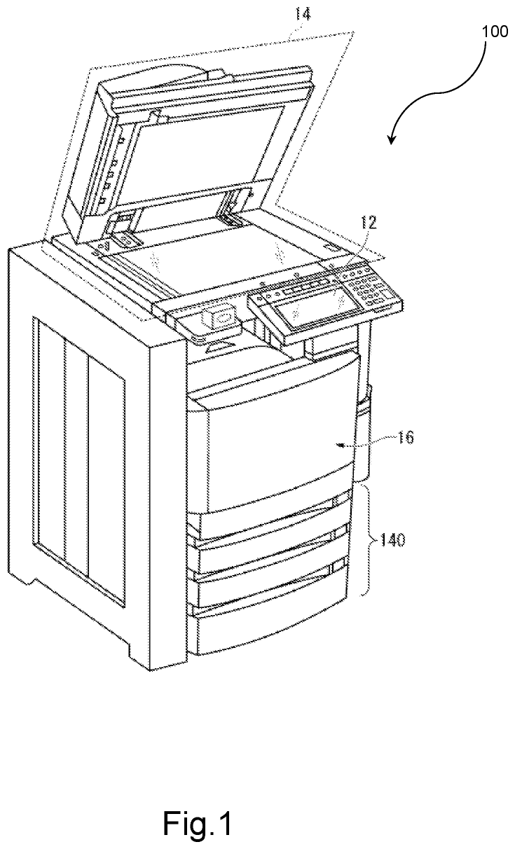

FIG. 1 is an outer appearance view showing an overall configuration example of an image forming apparatus 100 according to an embodiment. The image forming apparatus 100 according to the embodiment is, for example, a multifunction peripheral and has a copying function, a printer function, a scanner function, and a facsimile function.

The image forming apparatus 100 includes a control panel 12, a scanner 14, a printer 16, a camera 18, a sheet housing device 140, and a system controller 1.

The printer 16 forms an image on a sheet by using a developer such as a toner. The sheet is, for example, paper or label paper. The sheet may be anything as long as the image forming apparatus 100 can form an image on the surface thereof.

The scanner 14 reads image information to be read as brightness and darkness of light. The scanner 14 records the read image information in a main memory 4 of the system controller 1. The recorded image information may be transmitted to another information processing apparatus via a network. The recorded image information may be output to the printer 16 to form an image based on the image information on the sheet.

The control panel 12 includes a display and a plurality of buttons. The display is an image display apparatus such as a liquid crystal display or an organic electro luminescence (EL) display. The display includes a touch panel. The display shows various types of information regarding the image forming apparatus 100. The control panel 12 receives an operation of a user. For example, the control panel 12 displays an instruction screen for receiving a user's instruction to install an application program, and receives a user's installation instruction, which is input according to the instruction screen.

The sheet housing device 140 houses sheets to be used for image forming in the printer 16.

The printer 16 forms images on sheets on the basis of image information generated by the scanner 14 or image information received via a communication path. The printer 16 forms images by the following processing, for example. The image forming unit of the printer 16 forms electrostatic latent images on a photosensitive drum on the basis of the image information. The image forming unit of the printer 16 causes a developer to adhere to the electrostatic latent images to form visible images. The transfer unit of the printer 16 transfers the visible images to the sheet. The fixing unit of the printer 16 heats and pressurizes the sheet to fix the visible images onto the sheet. Note that the sheet on which the images are formed may be a sheet housed in the sheet housing device 140 or may be a sheet manually fed.

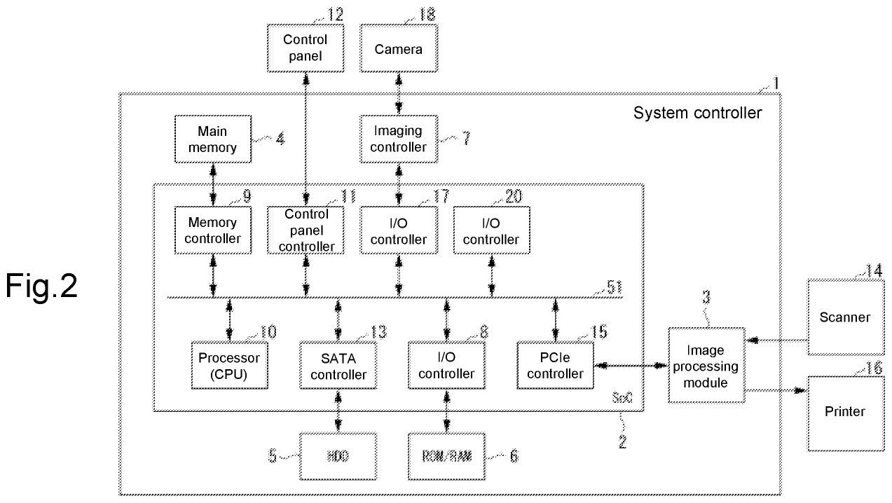

FIG. 2 is a block diagram showing a configuration of the system controller 1 that is a control system of the image forming apparatus 100 according to the embodiment. In FIG. 2, the system controller 1 includes a system large-scale integration (LSI) 2, an image processing module 3, the main memory 4, an HDD 5, a ROM/RAM 6, and an imaging controller 7. Further, the system controller 1 is connected to the control panel 12, the camera 18, the scanner 14, and the printer 16.

The system LSI 2 is a chip called a system on chip (SoC). The system LSI 2 includes an internal bus 51 capable of high-speed communication. The bus 51 is connected with a memory controller 9, a processor 10, a control panel controller 11, and a serial advanced technology attachment (SATA) controller 13. Additionally, the bus 51 is connected with I/O controllers 8, 17, and 20 and a peripheral component interconnect express (PCIe) controller 15.

The processor 10 is, for example, a central processing unit (CPU). Hereinafter, the processor 10 will be referred to as a CPU 10. The CPU 10 controls the overall operation of the image forming apparatus 100. Specifically, the CPU 10 causes a control program stored in the ROM/RAM 6 to be resident in the main memory 4 to control each unit on the basis of program contents. The memory controller 9 controls reading of a resident program from the main memory 4, storage of image data in the main memory 4, and reading of image data from the main memory 4 by an instruction of the CPU 10. The main memory 4 has a region capable of storing image information corresponding to a plurality of pages and, for example, can store image information transmitted from the scanner 14 by each page.

The SATA controller 13 connects the system LSI 2 and the HDD 5 to each other. The HDD 5 compresses and stores the image data or the like read by the scanner 14. The I/O controller 8 connects the system LSI 2 and the ROM/RAM 6 to each other. The ROM 6 stores a control program or the like. The RAM 6 temporarily stores data.

The PCIe controller 15 connects the system LSI 2 and the image processing module 3 to each other. The image processing module 3 performs compression processing or the like on the image data output from the scanner 14. Further, the image processing module 3 performs processing of decompressing the image data, for example, and outputs the resultant image data to the printer 16.

The I/O controller 17 connects the system LSI 2 and the imaging controller 7 to each other. The imaging controller 7 is connected to the camera 18. The imaging controller 7 controls the camera 18. Specifically, the imaging controller 7 instructs the camera 18 to image an approaching user by the instruction of the CPU 10. Imaged face data indicating the imaged user is stored in the main memory 4 via the I/O controller 17 and the like. It is also possible to image the face by the camera 18 and perform face authentication.

The control panel controller 11 connects the system LSI 2 and the control panel 12 to each other. The control panel controller 11 controls the control panel 12 by the instruction of the CPU 10. The control panel controller 11 includes an I/O controller and an LCD controller. The control panel controller 11 displays various types of information on the control panel 12 and outputs operation contents of the user to the CPU 10.

In this embodiment, only one of application programs that use the display of the control panel 12 can be activated at a time. In other words, for example, in the state where an application program A is activated, if another application program B is activated, the application program A will be terminated. In this termination, not only the display by the application program A but also the application program A itself are terminated. Note that the application program includes various programs and installation application programs for implementing the functions of the image forming apparatus. In the following description, the application will be simply referred to as “app” in some cases. Further, a program of the application will be simply referred to as an “app program” in some cases.

The image forming apparatus 100 is equipped with an installation application program for installing an application program. The installation application program is stored in the HDD 5 and expanded in the main memory 4 to be executed by the CPU 10. When an application program is installed, the installation application program temporarily terminates an application program in operation and then performs installation. Hence, a conventional installation application program cannot install its own program (new installation application program).

In this regard, in this embodiment, a proxy installation application program is mounted, which is for installing an installation application program on behalf of the installation application program when an installation application program is installed. Such a proxy installation application program may be installed in advance or may be installed when an installation application program is installed. Whether the proxy installation application program is installed in advance or the proxy installation application program is installed when an installation application program is installed can be set in advance by the user. Setting contents are stored in the HDD 5.

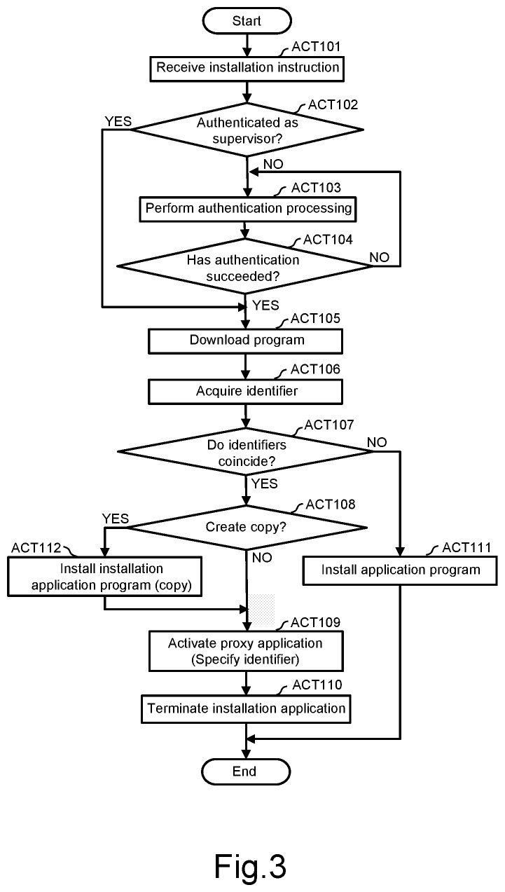

In this embodiment, if a proxy installation application program is installed when an installation application program is installed, a copy of an installation application program originally mounted is created and saved, and is installed as a proxy installation application program (see ACT112 of FIG. 3). Therefore, setting contents stored in the HDD 5 are contents indicating whether or not a copy of an installation application program originally mounted is created and installed.

Note that, in this embodiment, all application programs have unique identifiers. The identifiers can also be acquired from downloaded programs. Therefore, it is also possible to determine whether or not the downloaded program is an installation application program, for example (see ACT107 of FIG. 3). Further, in activating an application program, various types of information such as the identifier can be set as parameters of an application program to be activated. Further, the activation or termination of an application program is performed by a management module that manages application programs.

In the following description, an installation application program originally installed in the image forming apparatus 100 will be described as an installation application program “X”, and an installation application program newly installed will be described as an installation application program “Y”. If it is not necessary to distinguish between the installation application program “X” and the installation application program “Y”, those installation application programs will be each described as an installation application program. FIG. 3 is a flowchart showing the processing by the installation application program “X”. By way of example, the processing shown in FIG. 3 is assumed to be executed by the CPU 10, which activates the installation application program “X” and operates according to the installation application program “X”. The CPU 10 that operates according to the installation application program “X” will be described as a CPU 10 (installation application program), and the description thereof will be simplified. In ACT101 of FIG. 3, the CPU 10 (installation application program) receives an instruction to install an application program from the user via the control panel 12. In ACT102, the CPU 10 (installation application program) determines whether or not the user who has performed the installation instruction is authenticated as a supervisor who can install an application program. If the user is authenticated as a supervisor (ACT102: YES), the processing of the CPU 10 (installation application program) proceeds to ACT105.

If the user is not authenticated as a supervisor (ACT102: NO), the processing of the CPU 10 (installation application program) proceeds to ACT103. In ACT103, the CPU 10 (installation application program) performs authentication processing. Here, the CPU 10 (installation application program) performs processing of, for example, face authentication, authentication using passwords, or authentication using an IC card. In ACT104, the CPU 10 (installation application program) determines whether or not the authentication has succeeded. If the authentication has failed (ACT104: NO), the processing of the CPU 10 (installation application program) returns to the authentication processing (ACT103). If the authentication has succeeded (ACT104: YES), the processing of the CPU 10 (installation application program) proceeds to ACT105. In ACT105, the CPU 10 (installation application program) downloads an application program to be installed.

In ACT106, the CPU 10 (installation application program) acquires an identifier from the downloaded application program. In ACT107, the CPU 10 (installation application program) determines whether or not the acquired identifier coincides with the identifier of the installation application program “Y”. If the identifiers do not coincide with each other (ACT107: NO), the CPU 10 (installation application program) determines that the downloaded application program is not the installation application program “Y”. The processing of the CPU 10 (installation application program) then proceeds to ACT111. In ACT111, the CPU 10 (installation application program) installs the downloaded application program as it is, and terminates the processing.

On the other hand, if the identifiers coincide with each other (ACT107: YES), the CPU 10 (installation application program) determines that the downloaded application program is the installation application program “Y”. The processing of the CPU 10 (installation application program) then proceeds to ACT108. In ACT108, the CPU 10 (installation application program) determines whether to create a copy of the installation application program “X” or not. Here, the CPU 10 (installation application program) refers to the setting contents stored in the above-mentioned HDD 5 to determine whether to create a copy of the installation application program “X”. If a copy is not created (ACT108: NO), that is, if a proxy installation application program is installed in advance, the processing of the CPU 10 (installation application program) proceeds to ACT109. In ACT109, since a proxy installation application program is installed in advance, the CPU 10 (installation application program) activates the proxy installation application program. Note that the activation in this case means that the CPU 10 (installation application program) requests the above-mentioned management module to activate the proxy installation application program.

At that time, an application program, which serves as a file for installing a program, is specified as a parameter. As described above, only one of application programs that use the display can be activated at a time. Hence, in order to install the installation application program “Y”, in ACT110, the CPU 10 (installation application program) terminates the installation application program “X”. Thus, the processing by the installation application program “X” is terminated. Note that the installation application program “X” is terminated by the management module.

If a copy is created (ACT108: YES), that is, if a proxy installation application program is not installed in advance, the processing of the CPU 10 (installation application program) proceeds to ACT112. In ACT112, the CPU 10 (installation application program) creates a copy of the installation application program “X” and installs the copy as a proxy installation application program. At that time, the CPU 10 changes the identifier of the installation application programs “X” before copying to the identifier of the copied installation application program (proxy installation application program) (specifies the identifier). Subsequently, the processing of the CPU 10 (installation application program) proceeds to the above-mentioned ACT109.

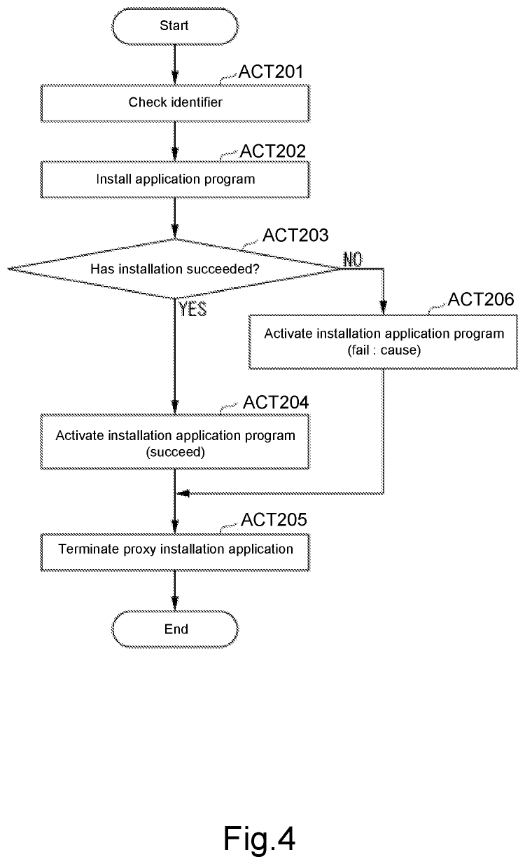

In such a manner, the proxy installation application program is activated. The processing by such a proxy installation application program will be described. FIG. 4 is a flowchart showing the processing by the proxy installation application program. By way of example, the processing shown in FIG. 4 is assumed to be executed by the CPU 10, which activates the proxy installation application program and operates according to the proxy installation application program. Further, the CPU 10 that operates according to the proxy installation application program will be descried as a CPU 10 (proxy installation application program), and the description thereof will be simplified. In ACT201 of FIG. 4, the CPU 10 (proxy installation application program) checks the identifier included in the file specified at the time of activation. In ACT202, if the identifiers do not coincide with each other, the CPU 10 (proxy installation application program) installs the installation application program “Y”. For example, if the identifier included in the specified file described above and the identifier of the installation application program “Y” do not coincide with each other, in ACT202, the CPU 10 (proxy installation application program) installs the installation application program “Y”. In ACT203, the CPU 10 (proxy installation application program) determines whether or not the installation of the installation application program “Y” has succeeded.

If the installation has succeeded (ACT203: YES), the processing of the CPU 10 (proxy installation application program) proceeds to ACT204. In ACT204, the CPU 10 (proxy installation application program) specifies information indicating that the installation has succeeded as a parameter, and activates the installation application program “Y”. By the success of the installation, the installation application program “Y” newly installed is activated. As described above, since only one of the applications that use the display can be activated at a time, in ACT205, the CPU 10 (proxy installation application program) terminates the proxy installation application program. Thus, the processing by the proxy installation application program is terminated. Note that the proxy installation application program is terminated by the management module that manages applications.

On the other hand, if the installation of the installation application program “Y” has failed (ACT203: NO), the processing of the CPU 10 (proxy installation application program) proceeds to ACT206. In ACT206, the CPU 10 (proxy installation application program) specifies information indicating the failure of the installation and its cause as a parameter and activates an installation application program. The processing of the CPU 10 (proxy installation application program) proceeds to ACT205. Due to the failure of the installation, the installation application program “X”, which is the same as that before installation, is activated. Note that the activation in ACT204 and ACT206 means that the CPU 10 (proxy installation application program) requests the above-mentioned management module to activate the installation application program.

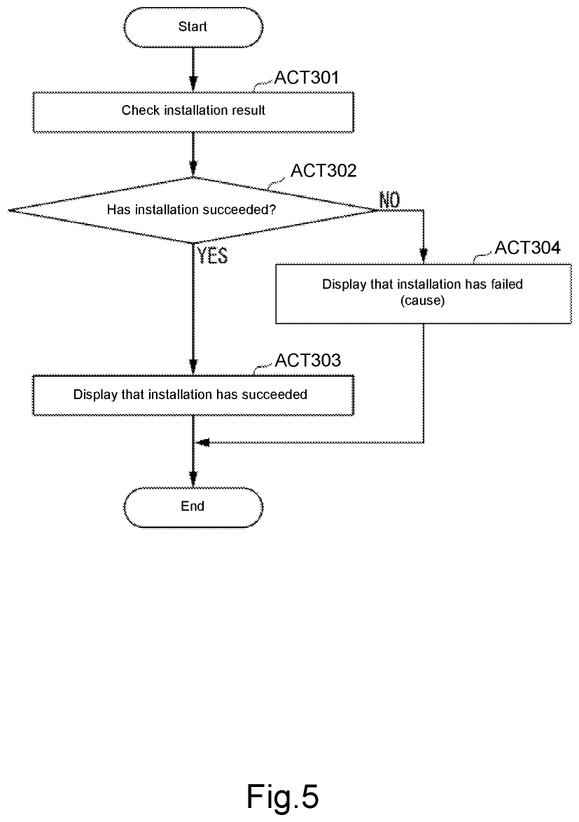

In such a manner, the installation application program is restarted. The processing by the installation application program to be restarted will be described. FIG. 5 is a flowchart showing a flow of processing by the installation application program at the time of restart. The processing shown in FIG. 5 is executed by the CPU 10, which restarts the installation application program and operates according to the proxy installation application program. In the following description of FIG. 5, the CPU 10 that operates according to the installation application program will be described as a CPU 10 (restarted installation application program), and the description thereof will be simplified. In ACT301, the CPU 10 (restarted installation application program) checks the installation result specified at the activation. Subsequently, in ACT302, the CPU 10 (restarted installation application program) determines whether or not the installation of the installation application program has succeeded.

If the installation has succeeded (ACT302: YES), the processing of the CPU 10 (restarted installation application program) proceeds to ACT303. In ACT303, the CPU 10 (restarted installation application program) displays the fact that the installation has succeeded on the display of the control panel 12 and terminates the processing. If the installation has failed (ACT302: NO), the processing of the CPU 10 (restarted installation application program) proceeds to ACT304. In ACT304, the CPU 10 (restarted installation application program) displays the fact that the installation has failed and its cause on the display of the control panel 12 and terminates the processing.

The embodiment described above makes it possible to install an installation application program. Note that instead of the CPU 10 (proxy installation application program), the above-mentioned management module may install the installation application program. Further, if a plurality of application programs including an installation application program are installed, the installation application program may install an installation application program last. Subsequently, the installation application program may display the installation results of the plurality of application programs after an installation application program is installed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, which is equipped with an installation application program for installing various application programs, the information processing apparatus comprising:
a control panel that displays an instruction screen for receiving a user's installation instruction of an application program and receives the user's installation instruction input according to the instruction screen;
a storage device that stores the installation application program and a proxy installation application program, the installation application program being an application program stored in advance for installing various application programs, the proxy installation application program being an application program for installing a new installation application program instead of the installation application program; and
a processor configured to
activate the installation application program and cause the control panel to display the instruction screen,
receive, by the control panel, the installation instruction of an application program, and
activate the proxy installation application program if the application program instructed by the installation instruction is the installation application program.

2. The information processing apparatus according to claim 1, wherein
the processor is configured to
determine whether or not the application program instructed by the installation instruction is the installation application program,
install, if the application program instructed by the installation instruction is not the installation application program, the instructed application program, and
activate the proxy installation application program if the application program instructed by the installation instruction is the installation application program.

3. The information processing apparatus according to claim 2, wherein
the processor is configured to specify a file for installing the instructed installation application program as a parameter when activating the proxy installation application program.

4. The information processing apparatus according to claim 3, wherein
the processor is configured to operate according to the proxy installation application program to install the instructed installation application program and then activate the installation application program installed with information indicating a result of the installation being specified as a parameter.

5. The information processing apparatus according to claim 1, wherein
the processor is configured to
copy the installation application program stored in advance if the application program instructed by the installation instruction is the installation application program, and
store the copied installation application program as the proxy installation application program in the storage device.

6. The information processing apparatus according to claim 5, wherein
the processor is configured to determine whether or not the proxy installation application program is stored in the storage device if the application program instructed by the installation instruction is the installation application program.

7. The information processing apparatus according to claim 6, wherein
the processor is configured to
copy the installation application program stored in advance if the proxy installation application program is not stored in the storage device,
store the copied installation application program as the proxy installation application program in the storage device, and
activate the stored proxy installation application program.

8. The information processing apparatus according to claim 6, wherein
the processor is configured to activate the proxy installation application program stored in the storage device if it is determined that the proxy installation application program is stored in the storage device.

9. A method of installing an application program for an information processing apparatus equipped with an installation application program for installing various application programs, the method comprising:
storing the installation application program and a proxy installation application program in a storage device, the installation application program being an application program stored in the storage device in advance for installing various application programs, the proxy installation application program being an application program for installing a new installation application program instead of the installation application program;
activating the installation application program to display an instruction screen for receiving a user's installation instruction of an application program;
receiving the user's installation instruction input according to the instruction screen; and
activating the proxy installation application program if the application program instructed by the installation instruction is the installation application program.

10. An image forming apparatus, which is equipped with an installation application program for installing an application program for image forming, the image forming apparatus comprising:
a control panel that displays an instruction screen for receiving a user's installation instruction of an application program and receives the user's installation instruction input according to the instruction screen;
a storage device that stores the installation application program and a proxy installation application program, the installation application program being an application program stored in advance for installing various application programs, the proxy installation application program being an application program for installing a new installation application program instead of the installation application program; and
a processor configured to
activate the installation application program and cause the control panel to display the instruction screen,
receive, by the control panel, the installation instruction of an application program, and
activate the proxy installation application program if the application program instructed by the installation instruction is the installation application program.
